(19) United States
(12) Patent Application Publication
(10) Pub. No.: US 2016/0134070 A1
(43) Pub. Date: May 12, 2016

(54) ELECTRICAL CONNECTOR WITH ROTATABLE PRONGS

(71) Applicant: Volex plc, London (GB)

(72) Inventors: Mui Lian Jessica Toh, Singapore (SG); Yuan Wen Mo, Singapore (SG)

(21) Appl. No.: 14/536,523

(22) Filed: Nov. 7, 2014

(51) Int. Cl. H01R 24/68; H01R 13/60

(52) U.S. Cl. CPC H01R 24/68; H01R 13/60; H01R 2103/00

(57) ABSTRACT

An electrical connector for connecting to a power adapter or an electrical device that includes prongs that can move between a storage position and a working position. One of the prongs may be located a greater distance from the terminals of the electrical connector than the other. A recess in the connector may allow the prongs to be accessed by a human finger when the prongs are in the storage position. The electrical connector may be detached from a corresponding electrical device, and have a slot that meets a rail of the electrical device to guide alignment of the electrical connector with the electrical device. The electrical device may also have a second recess that meets the recess of the electrical connector when the terminal housing is mated to the inlet of the electrical device.

### TECHNICAL FIELD

The present disclosure relates to an electrical connector, and more particularly to an electrical connector including prongs which can rotate between their working position and storage position.

### BACKGROUND

Electronic devices, and specifically portable electronic devices such as mobile phones, personal digital assistants (PDAs), digital still cameras, digital video cameras, notebook computers and the like have built-in batteries. If no external power supply apparatus is provided to power the portable electronic device, the built-in battery is usually used as the main power source. If the power supplied from the battery is insufficient, the user may simply plug into the electrical device an electrical connector of a power supply apparatus, such as a power adapter, to provide power for operating the electronic device and for charging the battery. A storage position for an electrical connector is desirable because it can be used while the connector is being transported, such as between home and an office, to prevent damage to the connector as well as other items a person may be carrying.

### SUMMARY

An electrical connector according to embodiments of the present application comprises a connector for connecting to a power adapter or directly connecting to an electrical device, and an electrical connector for connecting to a main supply. The connector for connecting to a power adapter includes a line terminal, and a neutral terminal. The electrical connector for connecting to a main supply includes a housing comprising a housing cover and a housing base, a line prong, and a neutral prong. Both the line prong and neutral prong are capable of rotating (or, more generally, moving) between a working position and a storage position. The system of the present application further comprises a cam configured to maintain the working position and the storage position.

An electrical connector according to embodiments of the present application comprises a pair of prongs capable of rotating between a working position and a storage position (where the prongs are inaccessible to an electrical outlet, and electrically disconnected from the terminals), a housing including a housing base and a housing cover, a recess which allows access to the prongs when in the storage position, a prong bridge for connecting the prongs which is capable of coaxially rotating together, and a cam being fixed to the prong bridge.

When the prongs are in the working position, they may be substantially perpendicular to the terminals. When the prongs are in the storage position, they may be substantially perpendicular to the terminals, and the position of the prongs when the prongs are in the working position. The ends of the prongs may be close to an edge of the electrical device when in the working position, and positioned away from the edge when in the storage position.

An electrical connector according to the present application is safe and convenient to the user. A line prong, and a neutral prong may easily and smoothly rotate between a working position and a storage position. Among those of skill in the art, this type of electrical connector may sometimes be referred to as being a duck-head-type electrical connector.

### BRIEF DESCRIPTION OF THE DRAWINGS

FIGS. 1A, 1B, 1C, 1D, and 1E illustrate an electrical connector with rotatable prongs and an associated electrical device that the electrical connector may detach from;

FIGS. 2A and 2B illustrate detail of the electrical connector with rotatable prongs of FIG. 1, with prongs displayed in the working position and storage position;

FIG. 3 illustrates an exploded view of the electrical connector with rotatable prongs of FIG. 1;

FIGS. 4A and 4B illustrate aspects of how the electrical connector with rotatable prongs may function to rotate, and to form an electrical connection;

FIG. 5 illustrates a detailed view of how a prong and terminal of the electrical connector with rotatable prongs of FIG. 1 may connect; and

FIG. 6 illustrates a cross-sectional and detailed view of how a prong of the electrical connector with rotatable prongs of FIG. 1 may maintain a working position or a storage position through use of a cam.

### DETAILED DESCRIPTION OF ILLUSTRATIVE EMBODIMENTS

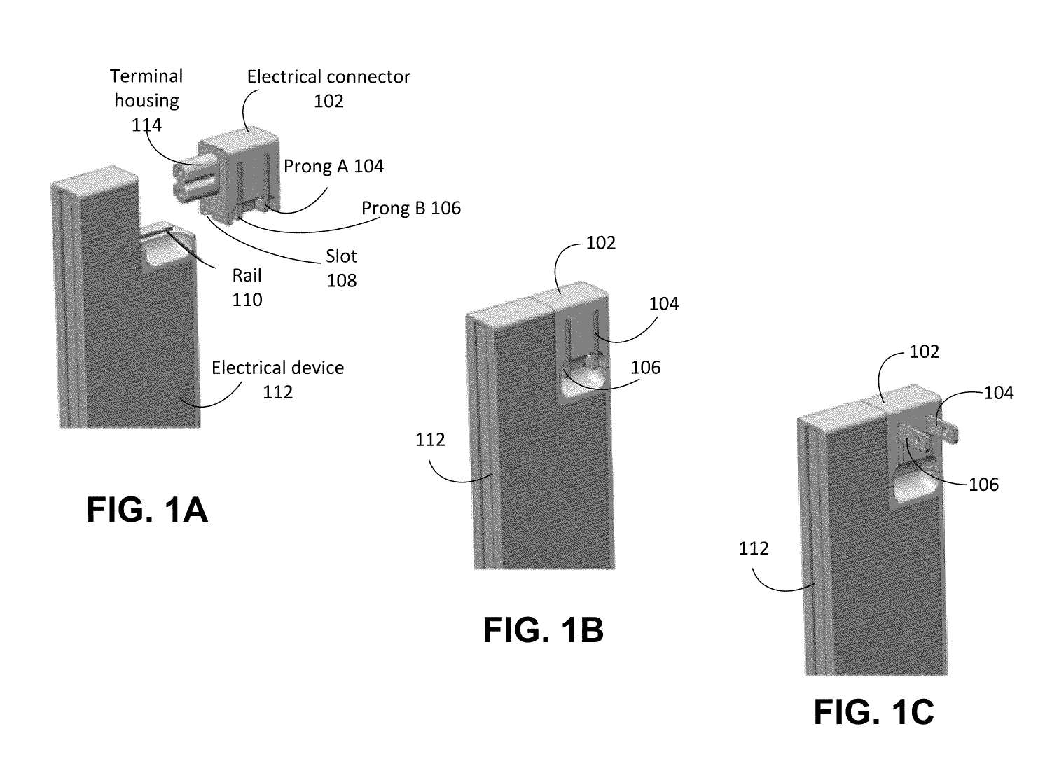

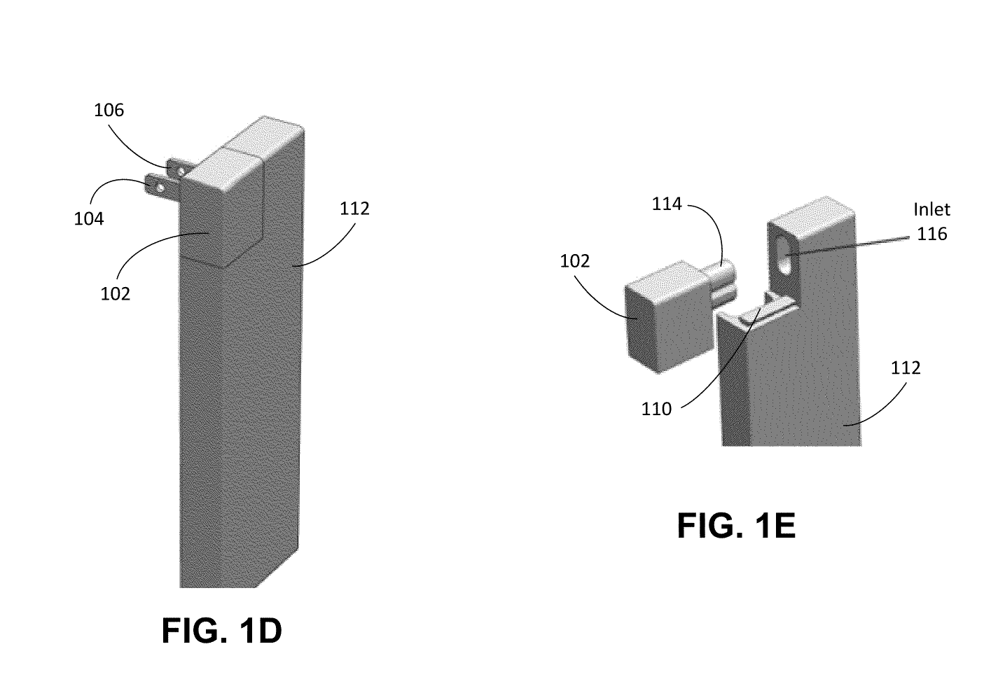

FIGS. 1A, 1B, 1C, 1D, and 1E illustrate an electrical connector with rotatable prongs and an associated electrical device that the electrical connector may detach from.

Electrical device 112 may operate as a power supply, which may or may not include a transformer or other means of converting different voltages and currents of the AC power to DC power. Many modern power supplies are switched mode supplies capable of converting 110-240 V AC power from a main supply to several output DC voltages and would therefore work with a range of different connectors and inlets. In the present illustration, however, if the terminal housing 114 is a C7 connector, then the inlet of the electrical adapter would be a C8 inlet. Where electrical device 112 does not make use of an adapter, and the electrical device itself includes an appropriate inlet (such as a C6 inlet), then the electrical connector 102 may be connected directly to the electrical device.

The electrical connector as disclosed herein can use plugs of any voltage standard and plugs supporting two or more voltage standards. The electrical connector can also use plugs of any shape, size, and type. For example, FIGS. 1-7 illustrate an electrical connector 102 with a type A plug used in the North America. As noted, alternative embodiments can be used with any other suitable plugs that include a prong A 104 and a prong B 106.

In FIG. 1A, electrical device 112 (which may be, for example, a power adapter) is configured to connect with terminal housing 114 of electrical connector 102 so that when prong A 104 and prong B 106 are plugged into an electrical outlet, electrical connector 102 will supply power to electrical device 112. As depicted, electrical connector 102 has a slot 108, and electrical device 112 has a corresponding rail 110, so that electrical connector 102 slides along rail 110 to make electrical contact with electrical device 112. It may be appreciated that there are other embodiments of this slot-and-rail aspect, such as where electrical connector 102 has a rail, and electrical device 112 has a corresponding slot.

Prong A 104 and prong B 106 may be made of an electrically conductive material, such as copper or brass. The other elements depicted in FIG. 1A (and FIGS. 1B-1E) may be made of a suitable insulation material, such as plastic. There are additional elements within electrical connector 102 that are depicted in the following figures that may be made of an electrically conductive material (such as terminals 332 and 334), and other elements that may be made of an insulator (such as prong bridge 550 and cam 770).

FIG. 1B then shows electrical connector 102 and electrical device 112 connected together. Electrical connector 102 has been slid along rail 110 via slot 108, and terminal housing 114 are in connection with electrical device 112. Also of note is that the prongs (prong A 104 and prong B 106) are in a storage position, where they are not able to be inserted into an electrical outlet. In the storage position, the ends of prongs 104 and 106, for insertion into a main supply, are positioned within from the common thickness of the connected electrical device 112 and electrical connector 102. As depicted in FIG. 1B, the ends of the prongs are positioned away from the shared top edge of electrical device 112 and electrical connector 102. FIG. 1C depicts a situation where the prongs have been rotated or moved into a working position, where the prongs are exposed relative to the housing of electrical connector 102, and the prongs are in a position where they may be inserted into an electrical outlet. In the working position depicted, the prongs have been moved close to be substantially perpendicular to electrical device 112.

FIG. 1D illustrates electrical connector 102 and electrical device 112 from a different angle. Note that in FIG. 1D, the prongs are in the working position. FIG. 1E illustrates the angle of FIG. 1D, where electrical connector 102 and electrical device 112 are not connected. The illustration of FIG. 1E illustrates a similar situation as FIG. 1A (where electrical connector 102 and electrical device 112 are not connected), but from a different angle.

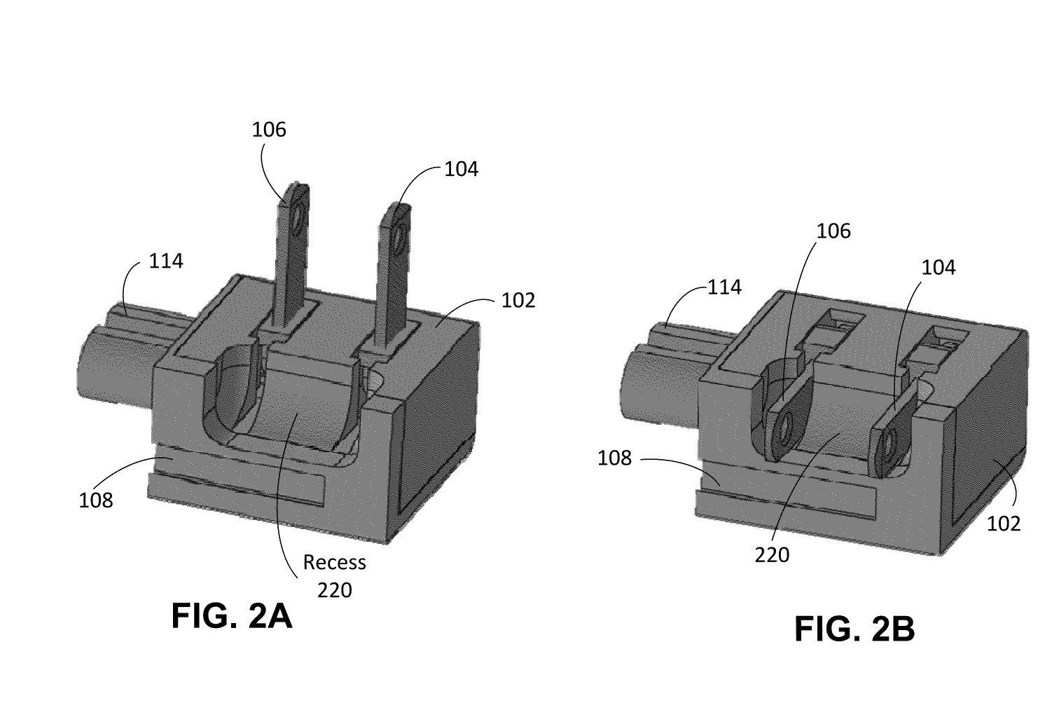

FIGS. 2A and 2B illustrate detail of the electrical connector with rotatable prongs of FIG. 1. FIG. 2A illustrates detail of the electrical connector with rotatable prongs of FIG. 1 where the prongs are in the working position, and FIG. 2B illustrates detail of the electrical connector with rotatable prongs of FIG. 1 where the prongs are in the storage position. As is seen, electrical connector 102 has recess 220, which gives spaces for a person to reach the prongs when they are in the storage position, and manually move them to the working position. Electrical device 112 (as depicted in FIG. 1) may have a corresponding recess that gives additional room for a person to reach the prongs when electrical connector 102 is connected with electrical device 112.

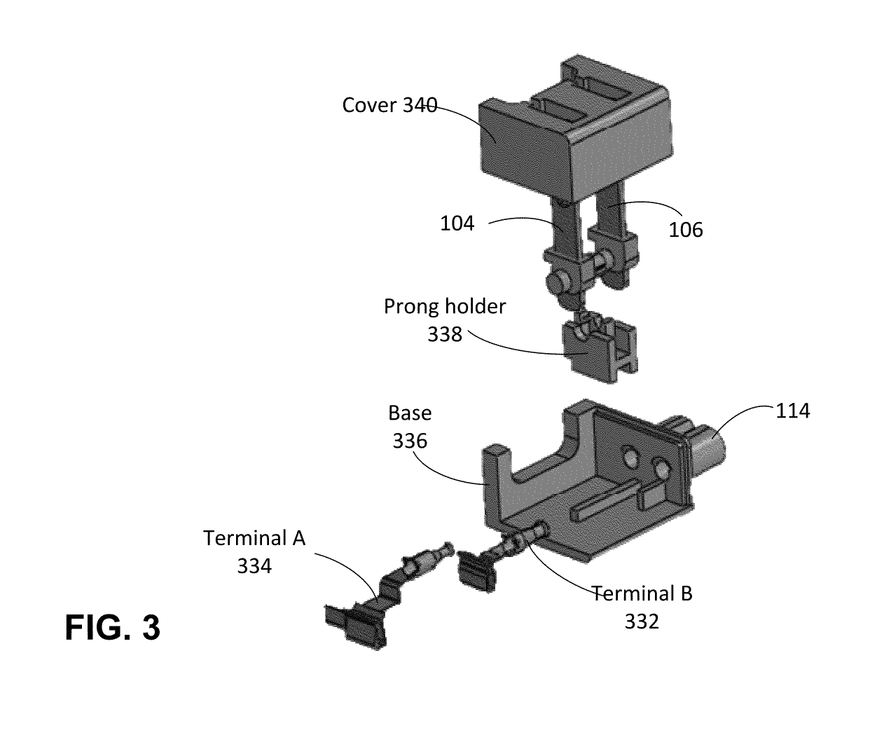

FIG. 3 illustrates an exploded view of the electrical connector with rotatable prongs of FIG. 1. A housing for electrical connector 102 is formed by cover 340 and base 336. Within base 336 are terminal A 334 and terminal B 332, which are inserted inside terminal housing 114 when the electrical connector is assembled. When a connection is made between the prongs and the terminals, terminal A 334 is in electrical contact with prong A 104, and terminal B 332 is in electrical contact with prong B 106. As depicted here, terminal A 334 is longer than terminal B 332 because, when electrical connector 102 is assembled, prong A 104 is located further from terminal housing 114 than prong B 106 is located from terminal housing 114. Also shown is prong holder 338, which provides a seat for the prong bridge 550 that the prongs may move, or rotate, upon.

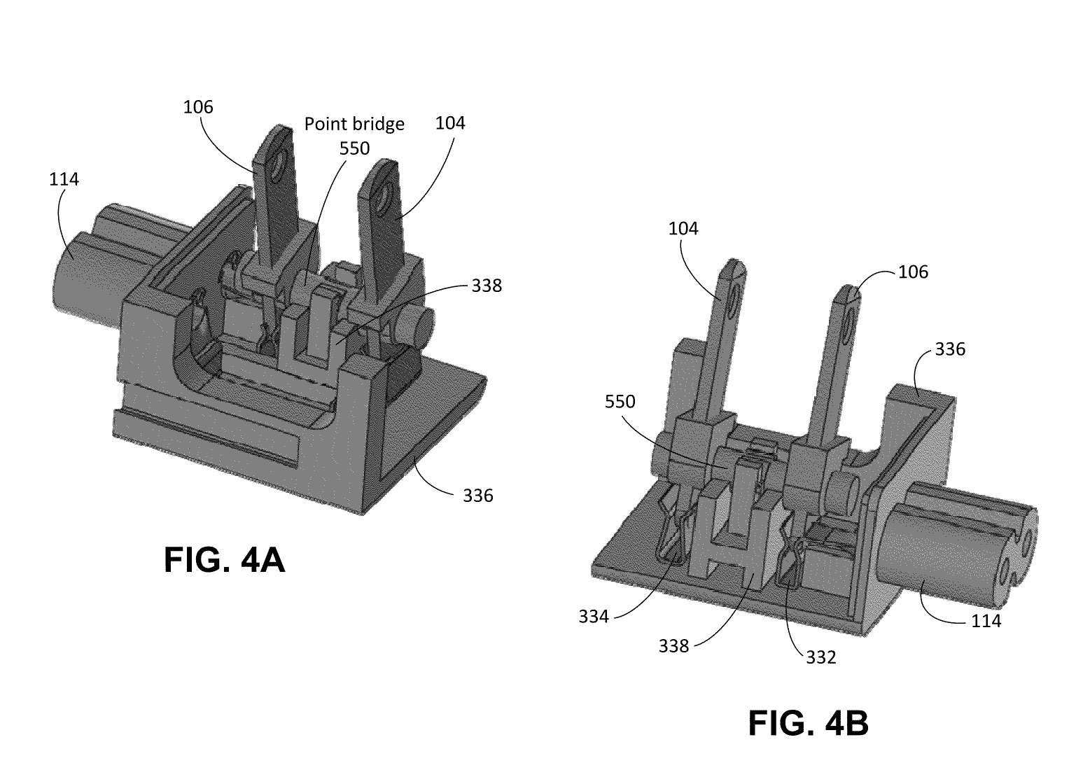

FIGS. 4A and 4B illustrate aspects of how the electrical connector with rotatable prongs may function to rotate, and to form an electrical connection. FIG. 4B illustrates the electrical prong rotated 180 degrees relative to FIG. 4A. The prongs are connected via prong bridge 550, which is made of an insulating material, such as plastic. Prong bridge 550 meets with prong holder 338, allowing the prongs to rotate about axis of prong bridge 550 FIG. 4B further depicts a slide-in connection between the prongs and the terminals. Prong A 104 connects with terminal A 334 via a slide-in connection that is built into terminal A 334. Similarly, prong B 106 connects with terminal B 336 via a slide-in connection that is built into terminal B 336.

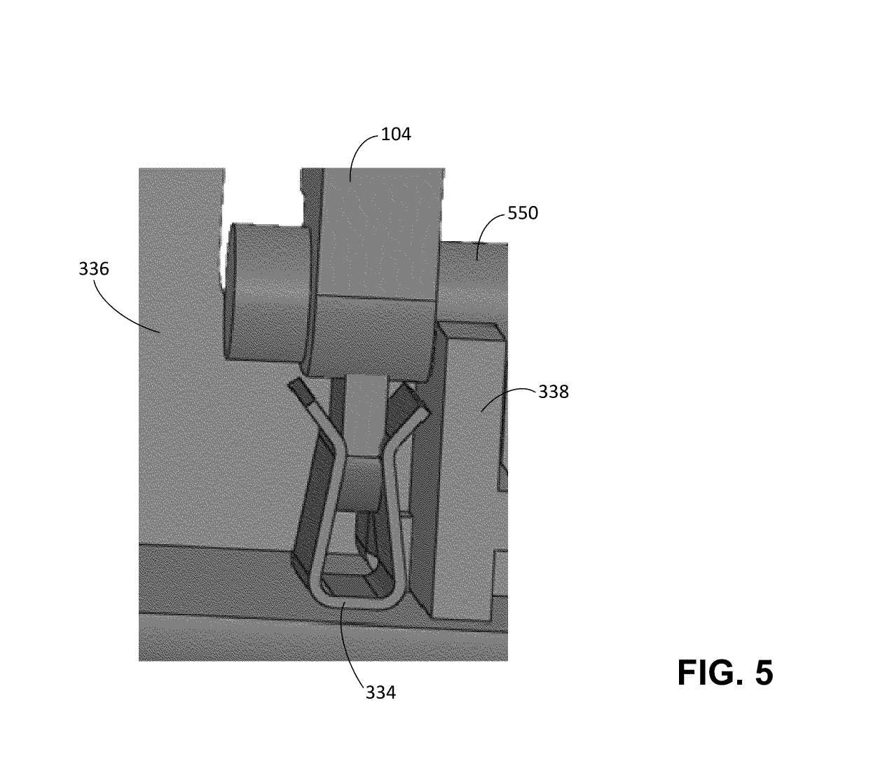

FIG. 5 illustrates a detailed view of how a prong and terminal of the electrical connector with rotatable prongs of FIG. 1 may connect. FIG. 5 is a detailed view of Prong A 104, terminal A 334, and a slide-in connection as depicted in FIG. 4B. Prong A 104 connects with terminal A 334 via a slide-in connection that is built into terminal A 334. This slide-in connection for prong A 104 connecting with terminal A 334 as depicted in FIG. 5 may be similar to the slide-in connection for prong B 106 connecting with terminal B 336.

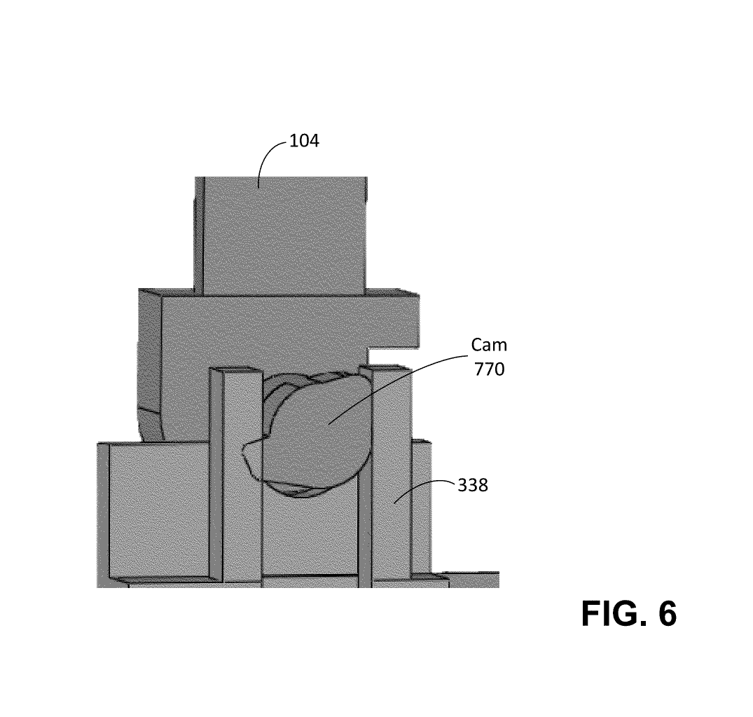

FIG. 6 illustrates a cross-sectional and detailed view of how a prong of the electrical connector with rotatable prongs of FIG. 1 may maintain a working position or a storage position through use of a cam. Cam 770 is part of prong bridge 550, and rotates with prong bridge 550. As depicted in FIG. 6, cam 770 has a profile that distorts the shape of prong holder 338 when rotated. When the prongs are rotated into the working position, cam 770 is positioned to maintain the position of, or resist movement, of the prongs when minor forces act upon the prongs. When greater forces toward the storage position act upon the prongs, cam 770 will distort prong holder 338, and the prongs will rotate toward the storage position.

Similarly, the profile of cam 770 is such that, when the prongs are in the storage position, cam 770 is positioned to maintain the position of, or resist movement, of the prongs when minor forces act upon the prongs. When greater forces toward the working position act upon the prongs, cam 770 will distort prong holder 338, and the prongs will rotate toward the working position.

In addition to the embodiments discussed above, it may be appreciated that there are various alterations, modifications, and improvements. For instance, the specific choice of materials with respect to the various components are within the ability of those skilled in the art according to the application, based on the functional indications given above. The specification and drawings are, accordingly, to be regarded in an illustrative rather than a restrictive sense. It will, however, be evident that various modifications and changes may be made thereunto without departing from the broader spirit and scope of the invention.

What is claimed:

1. An electrical connector system, comprising:
an electrical device for receiving an electrical connector;
a connector housing for the electrical connector;
terminals mounted on a side of the connector housing for connecting to a power adapter of the electrical device; and
prongs mounted within the connector housing having a storage position protected by the connector housing and a working position extending from the connector housing, the prongs being configured to move between the storage position and the working position.

2. The system of claim 1, wherein the connector housing forms a recess that allows the prongs to be accessed by a human finger when the prongs are in the storage position.

3. The system of claim 2, wherein the electrical device includes a device housing forming a second recess that aligns with the recess formed by the connector housing when the terminal housing is connected to the electrical device.

4. The system of claim 1, wherein the connector housing forms a slot that is substantially filled by a corresponding rail of the electrical device when the terminals are connected to the electrical device.

5. The system of claim 1, wherein the prongs are configured to move from the storage position to the working position by rotating between the storage position and the working position.

6. The system of claim 1, wherein ends of the prongs are configured to be substantially perpendicular to the electrical connector when in the working position, and wherein the ends of the prongs are positioned in line with the electrical device when in the storage position.

7. The system of claim 6, wherein the prongs are configured to move from the storage position to the working position by rotating between the storage position and the working position.

8. The system of claim 1, wherein the connector housing includes a housing cover and a housing base.

9. The system of claim 1, wherein the prongs are held together by a prong bridge in between.

10. The system of claim 9, wherein the prong bridge is coaxially coupled to the prongs such that they are capable of rotating together coaxially.

11. The system of claim 10, further comprising:
a cam being fixed to the prong bridge.

12. The system of claim 11, wherein the cam is configured to maintain the working position and the storage position.

13. The system of claim 1, further comprising:
a holder comprising an insulating material that holds the prongs within the connector.

14. The system of claim 12, wherein the holder is capable of allowing the movement of the prongs between the storage position and the working position.

15. The system of claim 1, wherein the prongs are inaccessible to an electrical outlet when in the storage position.

16. The system of claim 1, wherein the terminals are in slide-in connection with the prongs when the prongs are in the working position.

17. The system of claim 1, wherein the terminals are electrically disconnected from the prongs when the prongs are in the storage position.

18. The system of claim 1, wherein the prongs are substantially perpendicular to the terminals when the prongs are in the storage position.

19. The system of claim 1, wherein the prongs are substantially perpendicular to the terminals when the prongs are in the working position.
